(19) United States
(12) Patent Application Publication
(10) Pub. No.: US 2026/0082089 A1
(43) Pub. Date: Mar. 19, 2026

(54) SPARSE TENSOR-BASED BITWISE DEEP OCTREE CODING

(71) Applicant: InterDigital VC Holdings, Inc., Wilmington, DE (US)

(72) Inventors: Jiahao PANG, New York, NY (US); Muhammad Asad LODHI, New York, NY (US); Dong TIAN, Wilmington, DE (US)

(21) Appl. No.: 19/110,742

(22) PCT Filed: Oct. 3, 2023
(86) PCT No.: PCT/US2023/034393

§ 371 Date: Mar. 11, 2025

Related U.S. Application Data
(60) Provisional application No. 63/415,841, filed on Oct. 13, 2022.

(51) Int. Cl. H04N 19/96; H04N 19/132; H04N 19/136

(52) U.S. Cl. CPC H04N 19/96; H04N 19/132; H04N 19/136

(57) ABSTRACT

In one implementation, we propose a bitwise octree coding approach based on deep neural networks and operations on 3D sparse tensors. To encode/decode a certain level of detail (LoD) in an octree, geometric features are first inherited from the previous LoD by upsampling. Then based on the already encoded/decoded voxels, the point cloud geometry is firstly refined by pruning, followed by combining with the known context information. In the end, feature aggregation and probability estimation can be applied to obtain the occupancy probabilities for actual arithmetic encoding/decoding. A corresponding probabilistic training strategy is also proposed for our bitwise octree coding approach.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### SUMMARY

According to one embodiment, a method of encoding or decoding point cloud data is provided, comprising: obtaining features associated with point cloud data for a point cloud, said point cloud data is represented with a sparse tensor format at a level of detail (LoD); processing said features associated with said LoD to match a resolution of another LoD, wherein said another LoD is subsequent to said LoD; for each occupied voxel in said LoD, encoding or decoding a plurality of child voxels at said another LoD based on said processed features to obtain occupancy information at said another LoD; and updating said processed features, based on occupancy information at said another LoD, to generate updated features associated with said another LoD.

According to another embodiment, an apparatus for encoding or decoding point cloud data is provided, comprising one or more processors and at least one memory coupled to said one or more processors, wherein said one or more processors are configured to: obtain features associated with point cloud data for a point cloud, said point cloud data is represented with a sparse tensor format at a level of detail (LoD); process said features associated with said LoD to match a resolution of another LoD, wherein said another LoD is subsequent to said LoD; for each occupied voxel in said LoD, encode or decode a plurality of child voxels at said another LoD based on said processed features to obtain occupancy information at said another LoD; and update said processed features, based on occupancy information at said another LoD, to generate updated features associated with said another LoD.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding point cloud data according to the methods described herein.

One or more embodiments also provide a computer readable storage medium having stored thereon point cloud data generated according to the methods described above. One or more embodiments also provide a method and apparatus for transmitting or receiving the point cloud data generated according to the methods described herein.

### BRIEF DESCRIPTION OF THE DRAWINGS

FIG. 1 illustrates a block diagram of a system within which aspects of the present embodiments may be implemented.

FIG. 2A, FIG. 2B and FIG. 2C illustrate point-based, voxel-based, and sparse voxel-based point cloud representations, respectively.

FIG. 3 illustrates LoD construction of a point cloud.

FIG. 4 illustrates the coding order/steps of the voxels.

FIG. 5 illustrates bitwise encoding with context modeling.

FIG. 6 illustrates bitwise decoding with context modeling.

FIG. 7 illustrates an example of point clouds for encoding/decoding.

FIG. 8 illustrates feature inherited from the previous level by upsampling.

FIG. 9 illustrates encoding of the first group of bits/voxels, according to an embodiment.

FIG. 10 illustrates encoding of the second group of bits/voxels, according to an embodiment.

FIG. 11 illustrates encoding of the third group of bits/voxels, according to an embodiment.

FIG. 12 illustrates feature aggregation for the next LoD, according to an embodiment.

FIG. 13 illustrates decoding of the first group of bits/voxels, according to an embodiment.

FIG. 14 illustrates decoding of the second group of bits/voxels, according to an embodiment.

FIG. 15 illustrates decoding of the third group of bits/voxels, according to an embodiment.

FIG. 16A and FIG. 16B illustrate position representation and child voxel positions as context information, respectively, according to an embodiment.

FIG. 17 illustrates cascaded sparse convolutional layers for feature aggregation.

FIG. 18 illustrates a ResNet block for feature aggregation.

FIG. 19 illustrates an Inception-ResNet block for feature aggregation.

FIG. 20 illustrates a transformer block for feature aggregation.

FIG. 21 illustrates an architecture of the self-attention block.

FIG. 22 illustrates cascading of several feature aggregation modules.

FIG. 23 illustrates a probability estimation module.

FIG. 24 illustrates a probabilistic training strategy, according to an embodiment.

### DETAILED DESCRIPTION

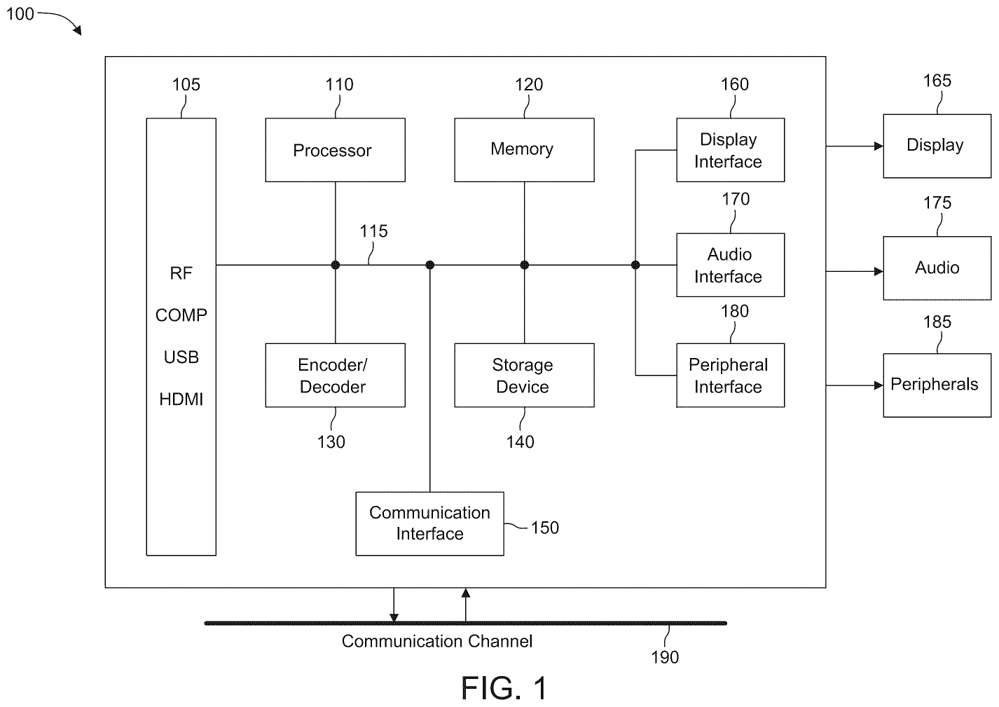

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-I, JPEG Pleno, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

In order to perform processing or inference on a point cloud, efficient storage methodologies are needed. To store and process an input point cloud with affordable computational cost, one solution is to down-sample the point cloud first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down-sampled) into a bitstream through entropy coding techniques for lossless compression. Better entropy models result in a smaller bitstream and hence more efficient compression. Additionally, the entropy models can also be paired with downstream tasks which allow the entropy encoder to maintain the task-specific information while compressing.

In addition to lossless coding, many scenarios seek lossy coding for significantly improved compression ratio while maintaining the induced distortion under certain quality levels.

We propose a method of lossless compression of voxelized point cloud data in a bitwise manner based on sparse tensor processing and deep learning. In the following, we first review voxel-based representation of point cloud data since octree coding relies on the voxel-based representation of point cloud. Then we review some octree coding methods, with a focus on bitwise octree coding methods.

### Voxel-Based Representation

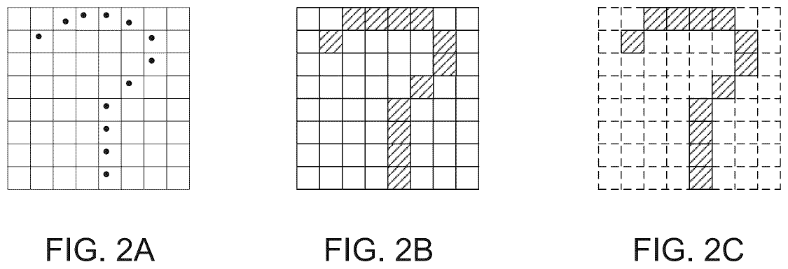

In a voxel-based representation, the 3D point coordinates, for example, as shown in FIG. 2A, are uniformly quantized by a quantization step size. Each point corresponds to an occupied voxel with a size equal to the quantization step, for example, as shown in FIG. 2B. Typically, a “1” will be assigned to the occupied voxel while a “0” will be assigned to an empty voxel, and the voxels are arranged as a 3-D array for random access.

However, naïve voxel representation may not be efficient in memory usage since most voxels are empty. To resolve this issue, sparse voxel representation is introduced where the occupied voxels are arranged in a sparse tensor format. A sparse tensor only keeps track of the positions and the features in its filled/occupied entries, thus enabling efficient storage and processing when most of the entries are empty. An example of a sparse voxel representation is depicted in FIG. 2C where the empty voxels (with dotted lines) do not consume memory, and only occupied voxels (with solid lines) need to be stored. Note that FIG. 2 and the rest of the figures are illustrated in 2D, just for simplification.

Having represented as 3D voxels, point clouds can be processed/digested with 3D convolutional neural networks—this is inspired by the success of applying 2D convolutional neural networks to 2D images. With regular 3D convolutions, a 3D kernel is overlaid on every location specified by a stride step no matter whether the voxels are occupied or empty. To avoid computation and memory consumption incurred by empty voxels, sparse 3D convolutional layers can be applied if the point cloud voxels are represented by a sparse tensor.

### Point Cloud Compression Via Octree Coding

Voxelized point clouds can be represented via an octree decomposition tree. First, a root node covers the whole 3D space in a bounding box. Then the space is equally split along every direction, i.e., x-, y-, and z-directions, leading to 2×2×2=8 voxels. For each voxel, if there is at least one point, the voxel is marked to be occupied and represented by “1”; otherwise, it is marked to be empty and represented by “0”. This step leads to the first level of detail (LoD) of the input point cloud. The voxel splitting then continues, resulting in the second LoD of the input point cloud which has a size of 2³×2³×2³. The voxel can be further split until a pre-specified condition is met.

Bytewise octree coding: A popular approach to encode an octree is by encoding each occupied voxel with an 8-bit value, i.e., 1 byte. It indicates the occupancy of its individual octant. In this way, we first encode the root voxel node by an 8-bit value. Then for each occupied voxel in the next level, we encode its 8-bit occupancy symbol, then move to the next level. We call this type of octree coding algorithm encoding the 8-bit occupancy symbols the bytewise octree coding method.

Bitwise octree coding: An alternative viewpoint to encode an octree is by directly encoding the binary occupancy bits of every voxel. At each LoD, we encode a sequence of occupancy bits representing the voxels at the current LoD, then we encode the next LoD. We call this type of approach the bitwise octree coding method. Our methods are proposed for this type of approach.

Comparing these two types of coding methods, we see that in the bytewise octree coding method, the coding of a current voxel is essentially coding the occupancy symbols of its child voxels. Differently, in the bitwise octree coding method, the coding of a current voxel is indeed coding the binary occupancy bit of its own. In the following, we review the bitwise octree coding approach in detail.

### Bitwise Octree Coding

In an article by Kaya, Emre Can, et al., entitled “Neural Network Modeling of Probabilities for Coding the Octree Representation of Point Clouds,” MMSP 2021 (hereinafter “Kaya”), the authors use the occupancy bits of the neighboring voxels in the same LoD as the context information to predict the occupancy probability of the current voxel. The prediction is performed via a neural network containing simple multi-layer perceptron (MLP) layers. Having accomplished the prediction of the probabilities, an adaptive arithmetic coder is applied to encode the occupancy bit.

In an article SparsePCGC by Wang, Jianqiang, et al., entitled “Sparse Tensor-based Multiscale Representation for Point Cloud Geometry Compression,” arXiv preprint arXiv:2111.10633, 2021 (hereinafter “SparsePCGC”), the authors also utilize neural networks to predict the occupancy probabilities. In contrast to Kaya, SparsePCGC uses sparse 3D convolutional layers to construct a neural network for probability estimation. However, the design of SparsePCGC employs a complex multi-stage design where each stage involves dedicated convolutional layers designed to estimate the probability of a particular child voxel. Moreover, in SparsePCGC, the probability estimation of a particular LoD does not take into account the features from the previous LoD, which fails to fully leverage the benefit of the neural networks.

A commonly owned patent application (Attorney Docket 2021PF00298) also introduces a method for bitwise octree coding. It proposes to summarize the available context information of a voxel to a more concise/condensed representation that is more friendly for probability estimation. This summarization process can either be non-learning-based or learning-based. The methods proposed here differ in two aspects. Firstly, the proposed methods use a fully learning-based approach. Secondly, the proposed methods view the point cloud to be encoded as a sparse tensor and utilizes sparse tensor operators to estimate the occupancy probabilities effectively and efficiently.

Another commonly owned patent application (Attorney Docket 2022PF00245) proposes a learning-based bitwise octree coding. However, it was proposed to estimate the occupancy probabilities of the current LoD in the voxel grids of the previous LoD. In other words, it estimates the higher-resolution occupancy probabilities based on the features of a lower resolution. The main motivation of such a design choice is to reduce the computational cost, and it differs from the methods proposed here and also from SparsePCGC.

As described above, the proposed methods are directed to a bitwise octree coding scheme. In the following, we first provide the system overview on bitwise octree coding, then elaborate on our proposal.

### Hierarchical Coding Structure

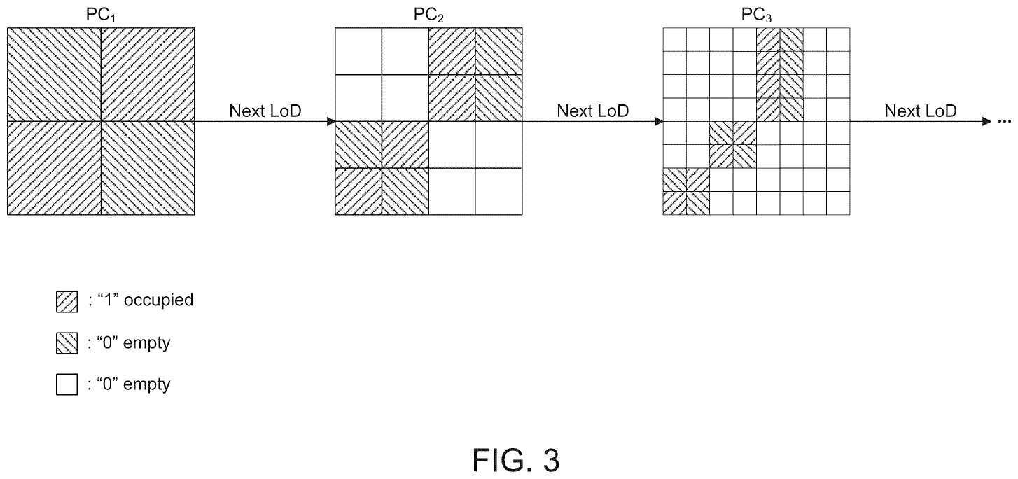

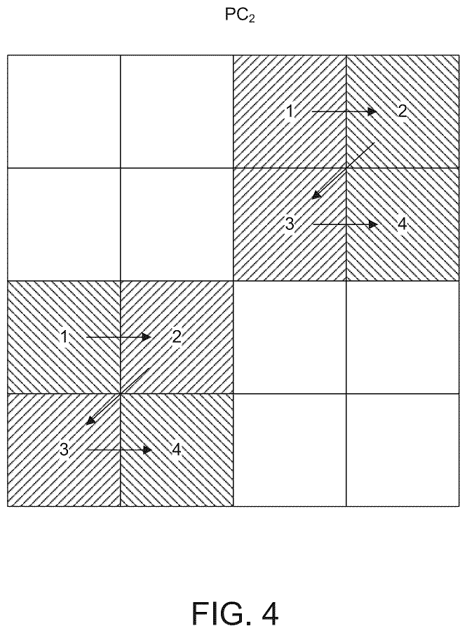

We intend to compress an octree hierarchically, by directly encoding the binary occupancy status of the voxels. Given an input point cloud with a bit-depth of N, we encode and decode this input point cloud hierarchically, as illustrated in FIG. 3.

On the encoder side, we first construct its coarsest voxel representation PC₁ at the first LOD, and PC₁ is firstly encoded and sent as a first bitstream BS₁. Then the next LoD, PC₂, is constructed. By comparing PC₂ and PC₁, we know that to encode PC₂, only its hatched voxels need to be encoded because the white voxels are guaranteed to be empty by checking PC₁. Hence, the hatched voxels of PC₂ are encoded and sent as a second bitstream BS₂. Next, we construct an even finer LoD, PC₃. Again, by comparing PC₃ and PC₂, we encode only the hatched voxels in PC₃, leading to a third bitstream BS₃. This procedure repeats until the finest bit-depth N of the point cloud is reached.

Similarly, on the decoder side, we first reconstruct the coarsest LoD of the point cloud, PC₁, by decoding the first bitstream BS₁. By referring to the already decoded PC₁, we know that the hatched voxels in PC₂ are included in the second bitstream BS₂. Hence, we decode BS₂ and put the decoded bits to the hatched voxels of PC₂ to reconstruct it. Similarly, the third bitstream BS₃ is also decoded, and the decoded bits are assigned to the hatched voxels of PC₃ for reconstruction. This procedure repeats until the finest bit-depth of the point cloud is reached.

### Context-Based Bitwise Octree Coding

To achieve a high compression ratio when encoding a certain LOD, the bitwise octree coding algorithm relies on an arithmetic coder and an effective mechanism to estimate the occupancy probability of every voxel to be encoded/decoded. We take the compression of the second LoD, PC₂ as shown in FIG. 3, as an example to illustrate how to perform encoding/decoding of a LoD using occupancy probability estimation and arithmetic coding.

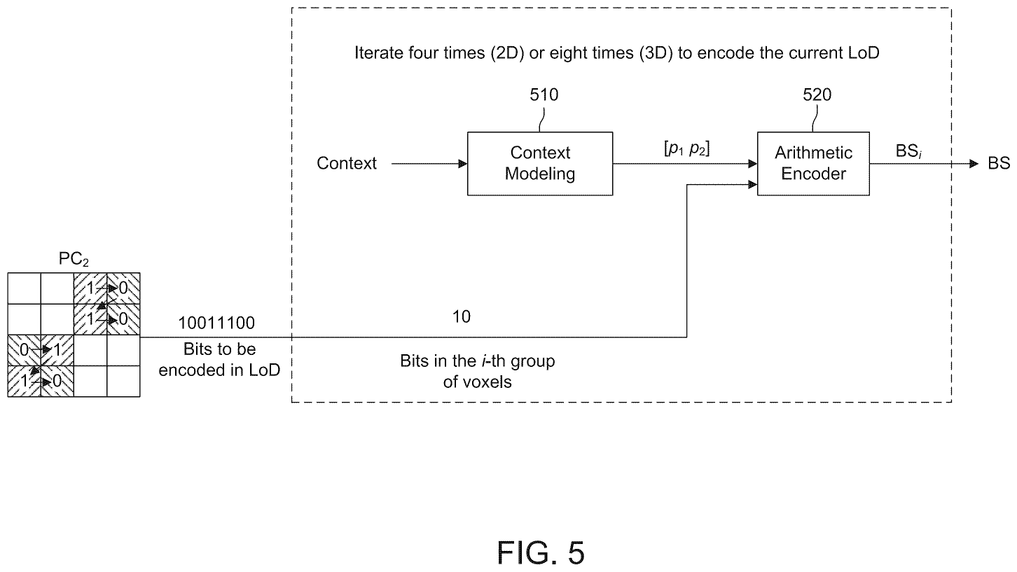

Firstly, the compression of PC₂ is split into 8 steps (for 3D), where each step encodes a group of bits/voxels lying in a particular position with respect to its parent voxel. We illustrate this design as a 2D example in FIG. 4. In this 2D case, we encode the group of bits/voxels labeled as ‘1’ in the first step because they are all in the upper-left corner of their parent voxel, then encode the group of bits/voxels labeled as ‘2’ in the second step because they are all in the upper-right corner of their parent voxel, and so on. Note that in this 2D case, only four steps are sufficient to encode all the voxels as indicated in FIG. 5 where each step covers a group of voxels. However, eight steps are needed in 3D since each parent voxel would be split into eight child voxels in 3D, i.e., there are eight groups of voxels in 3D.

A block diagram of the actual encoding process of PC₂ is shown in FIG. 5. As stated previously, the whole encoding process is split into several steps. Within the i-th step (the dotted block), a context modeling module (510) estimates the occupancy probabilities of the i-th group of bits/voxels. The estimation of the occupancy probability is based on the already encoded bits, and other known information about the voxel group, such as their coordinates. With the estimated probabilities ([p₁ p₂] in FIG. 5), the arithmetic encoder (520) encodes the input bits associated with the current step and outputs a sub-bitstream BSᵢ. The final encoded bitstream BS is obtained by combining all the sub-bitstreams.

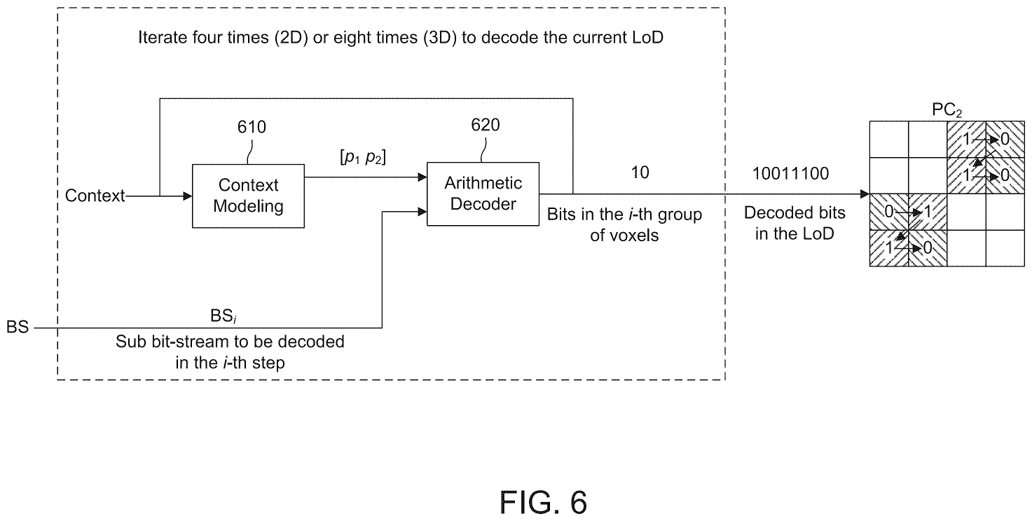

The decoding process inverts the encoding, as shown in the block diagram of FIG. 6. Again, the decoding is split into several steps. Within the i-th step (the dotted block), a context modeling module (610) estimates the occupancy probabilities of the i-th group of voxels. The estimation of the occupancy probability is based on the already decoded bits, and other known information about the voxel group, such as their coordinates. With the estimated probabilities ([p₁ p₂] in FIG. 6), the arithmetic decoder (620) outputs the occupancy bits associated with the current step. The final decoded bits are obtained by concatenating all the decoded bits obtained in each step.

We note that the probabilities output by the context modeling module during decoding are the same as the ones output during encoding, that is how the occupancy bits are compressed losslessly. Moreover, the context model essentially models the entropy of the bitstream, the more accurate the occupancy probabilities are, the smaller the output bitstream BS would be. Therefore, it is crucial to have a good context modeling method in octree coding.

Given the already encoded/decoded voxels, our proposed methods aim to model the occupancy probabilities based on the voxel-wise features inherited from the previous LoD by applying operations on sparse tensors.

### Encoder

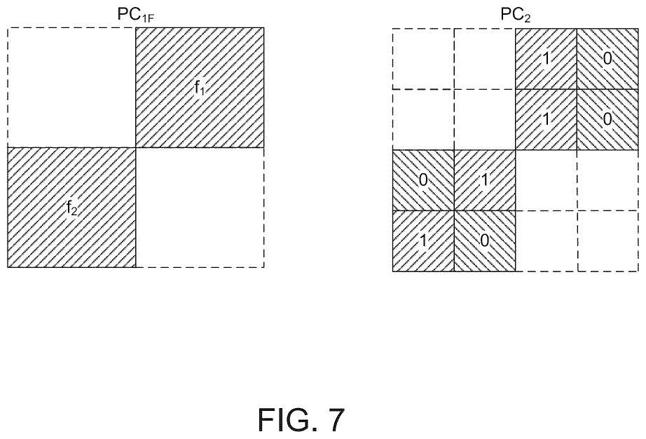

We illustrate our encoder steps with a concrete example. As shown in FIG. 7, suppose we have already encoded a point cloud PC_{1F}— the first LoD of the input point cloud equipped with geometric features f₁ and f₂ in each of its occupied voxels. We aim to encode the second LoD of the input point cloud, PC₂. These geometric features are abstract, high-level features generated by deep neural networks. They describe the occupancy status of their nearby voxels at the current LoD. The geometric features f₁ and f₂ can be represented as vectors, e.g., they can be vectors of length 64. As discussed above, only the hatched voxels in PC₂ need to be encoded, because the rest of the voxels are assured to be empty by checking PC_{1F}. Moreover, we represent both PC_{1F} and PC₂ in the sparse tensor format. Thus, voxels surrounded by dotted lines in FIG. 7 do not consume memory/storage.

Note that at the very beginning when encoding the first LoD of the point cloud (PC₁), the point cloud from its previous LoD, PC_{0F} is simply one voxel representing the whole space. In this case, its geometric feature is set to be a constant, e.g., a feature with all 1's.

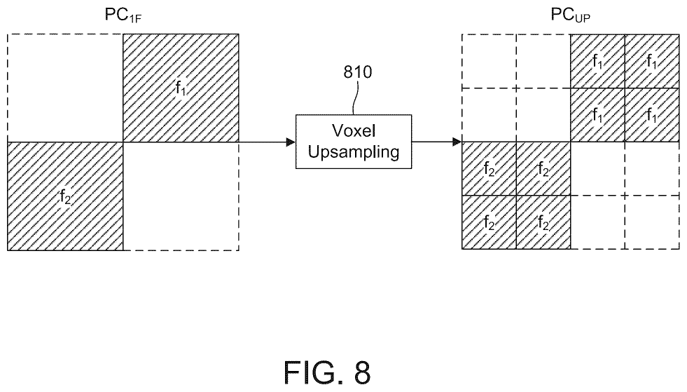

A preparation step of encoding is to apply a voxel upsampling module (810) to PC_{1F}, leading to an upsampled point cloud PC_{UP}, as shown in FIG. 8. The upsampled point cloud PC_{UP} has the same resolution/LoD as PC₂ while its features are directly obtained/inherited from PC_{1F}. This upsampling step serves as a common preparation for the subsequent steps to encode each group of voxels in PC₂.

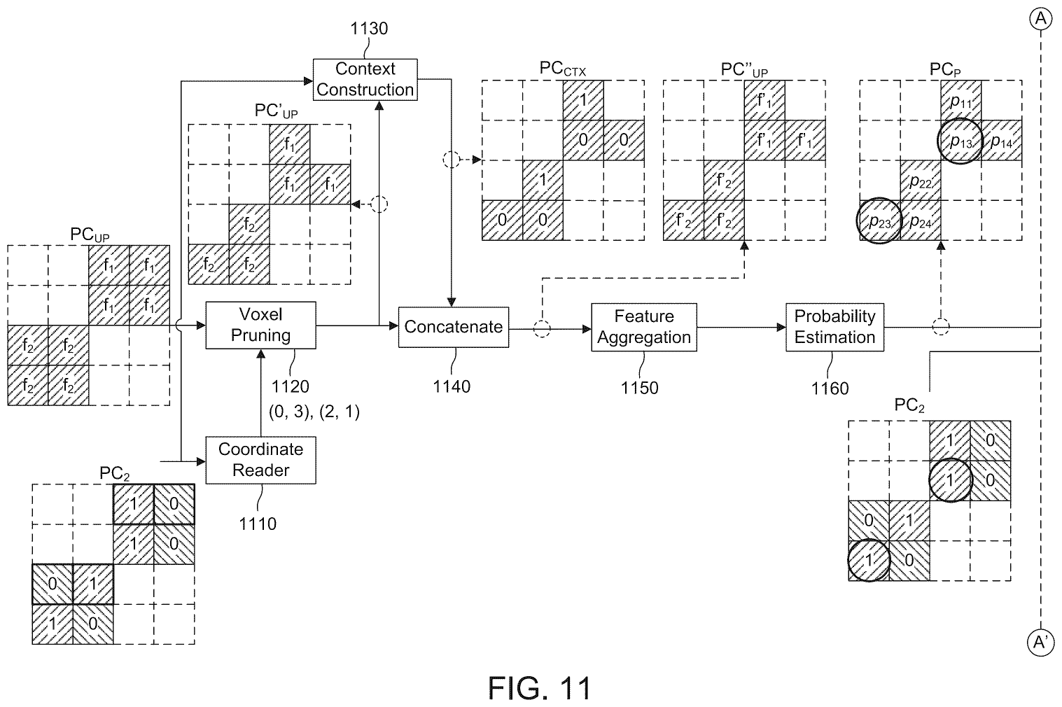

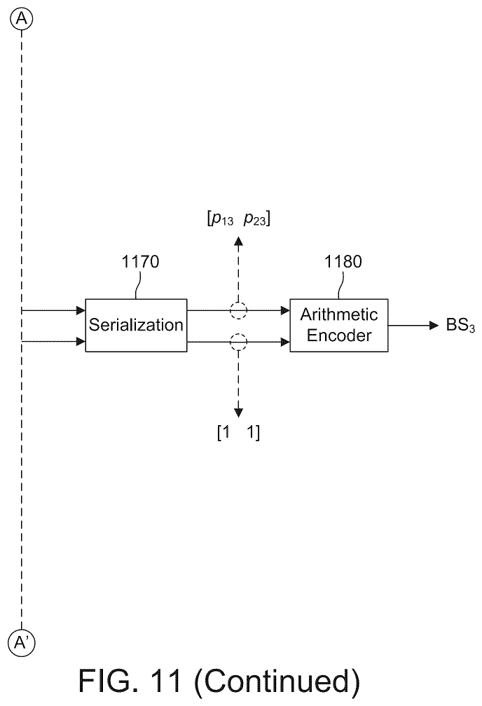

Next, we start the actual encoding process. We start our description with the encoding of the third group of bits in PC₂ (the bits labeled as 3 in FIG. 4), which involves a more general encoding pipeline than the first or second group of bits in PC₂. The whole encoding pipeline to encode the third group of bits in PC₂ is shown in FIG. 11. In this case, the first and the second groups of bits in PC₂ are already encoded. See PC₂ in FIG. 11, in which the four voxels in bold are already encoded. And we intend to utilize these already encoded bits for context modeling.

Firstly, a coordinate reader module (1110) locates all the already encoded voxels that are empty from PC₂. In this example, the voxels at positions (0, 3) and (2, 1) are located by the coordinate reader module. After that, these voxels are removed/pruned from PC_{UP} using the voxel pruning module (1120), leading to the pruned point cloud PC′_{UP}. This step is to refine the geometry of PC_{UP} based on the already encoded bits.

Secondly, we construct a context point cloud PC_{CTX} using the context construction module (1130). PC_{CTX} includes all the bitwise/voxel-wise discriminative information for predicting the occupancy probability. The context point cloud PC_{CTX} is also represented in the sparse tensor format, and it shares the same voxel geometry as PC′_{UP}. In one embodiment, we construct binary context information for occupancy probability prediction. For each occupied voxel in PC_{CTX}, if its co-located voxel in PC₂ is already encoded and occupied, we put a “1” in this voxel; if its co-located voxel in PC₂ is not encoded yet, we put an “0” in this voxel. Be reminded that for an occupied voxel in PC_{CTX}, its co-located voxel in PC₂ cannot be both encoded and unoccupied because such voxels have already been removed by the voxel pruning module in the previous step.

Thirdly, the context point cloud PC_{CTX} and the pruned point cloud PC′_{UP} are concatenated (1140), which puts the voxel-wise feature and the local context information together and results in a new point cloud PC″_{UP}. Specifically, in this step, the concatenation module concatenates the corresponding features in PC_{CTX} and PC′_{UP} for each occupied voxel to generate PC″_{UP}. PC″_{UP} is then fed to a feature aggregation module (1150)—a neural network module—to further refine/improve the voxel-wise feature. The output of the feature aggregation module is then fed to a probability estimation module (1160), which is also a neural network module to estimate the occupancy probabilities of the voxels in PC″_{UP}. It outputs a probability point cloud PCₚ where each voxel contains its own estimated occupancy probability. The feature aggregation module mainly consists of sparse convolutional layers, while the probability estimation module mainly consists of multi-layer perceptron (MLP) layers.

In the end, the occupancy probabilities of the third voxel group are serialized by the serialization module (1170). The serialization module is to take out the estimated occupancy probabilities of the third voxel group, i.e., p₁₃ and p₂₃, from the probability point cloud PCₚ and put them onto a 1-D array. In the example in FIG. 11, it outputs an array [p₁₃ p₂₃]. This serialization step is to get prepared for the arithmetic coding which will be launched next. On the other hand, the ground-truth occupancy status of the third voxel group is also serialized. In the example of FIG. 11, it leads to an array [1 1]. The serialized occupancy probabilities and the serialized ground-truth occupancies are then fed to the arithmetic encoder (1180) to generate the sub-bitstream for the third voxel group, BS₃.

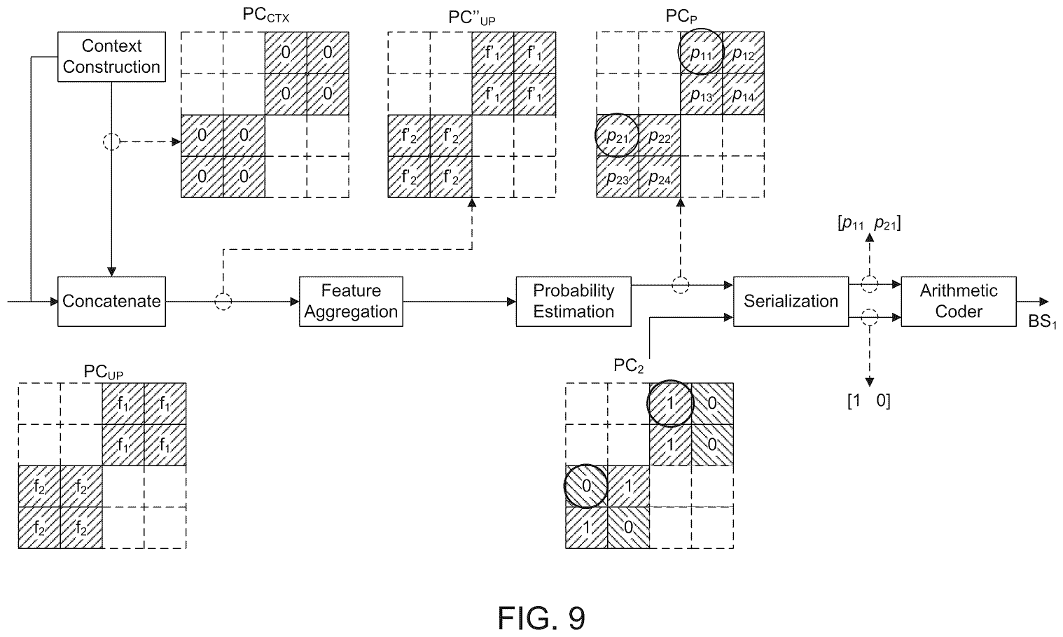

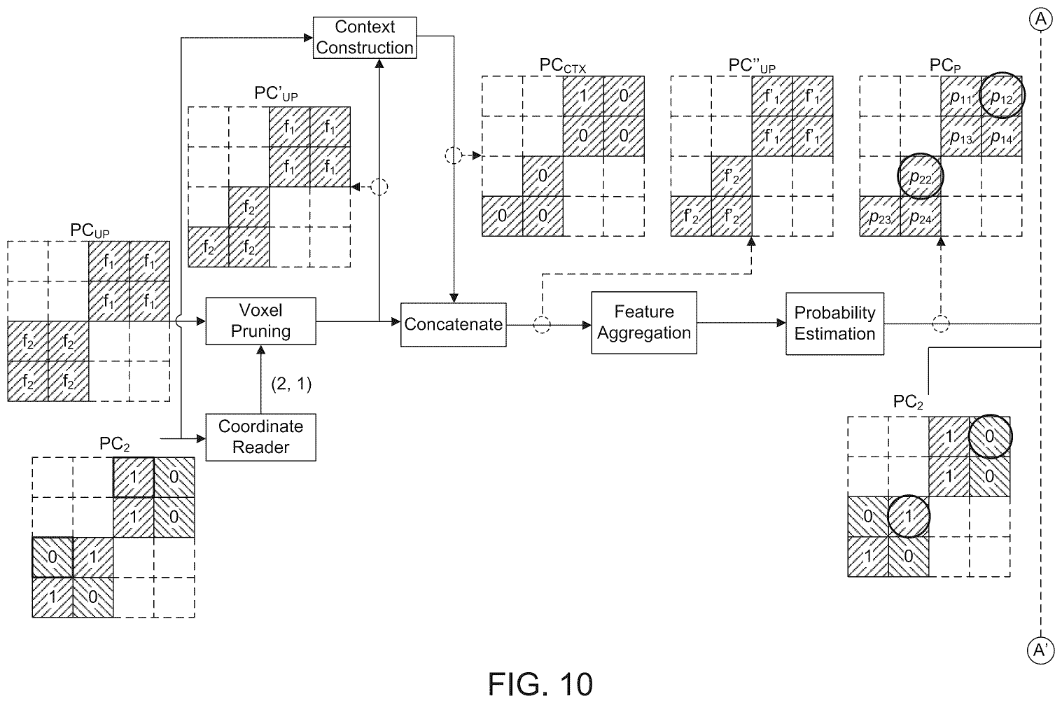

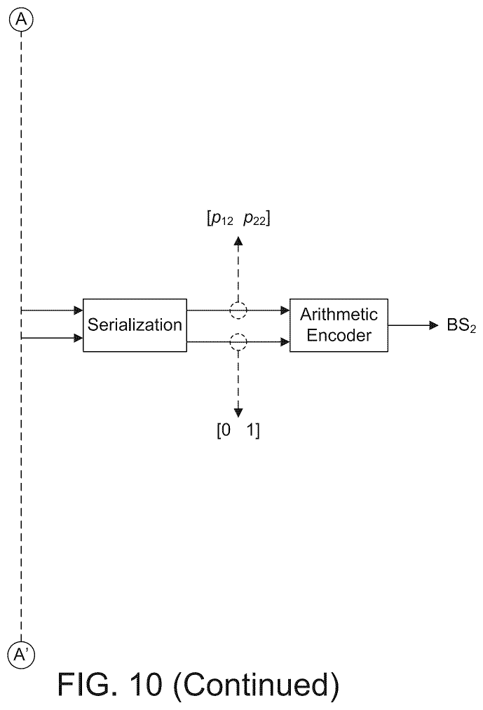

Note that the encoding process of the second voxel group is also illustrated in FIG. 10 which has the same procedure as FIG. 11. The encoding process of the first voxel group is a special (and simplified) case of the encoding of other voxel groups, as shown in FIG. 9. Because at the beginning of the encoding, there are no voxels/bits that are already encoded, there are no voxels that need to be pruned from PC_{UP}. Thus, PC_{UP} is directly fed to the concatenation module instead of its pruned version. Moreover, the context construction module also directly outputs PC_{CTX} with all zeros on its voxels since there are no encoded voxels. Note in a simplified implementation, the voxel groups other than the first voxel group can also follow the process as shown in FIG. 9, namely, voxel pruning (1120) is not performed and/or all contexts are set to zeros. In this case, the information from previously encoded bits is partially used or not used. However, since the geometric information of the previous LoD is propagated to the current LoD through the geometric features in PC_{UP}, the occupancy probability estimation module can still perform reasonably well even though the information from the previously encoded bits is not fully utilized.

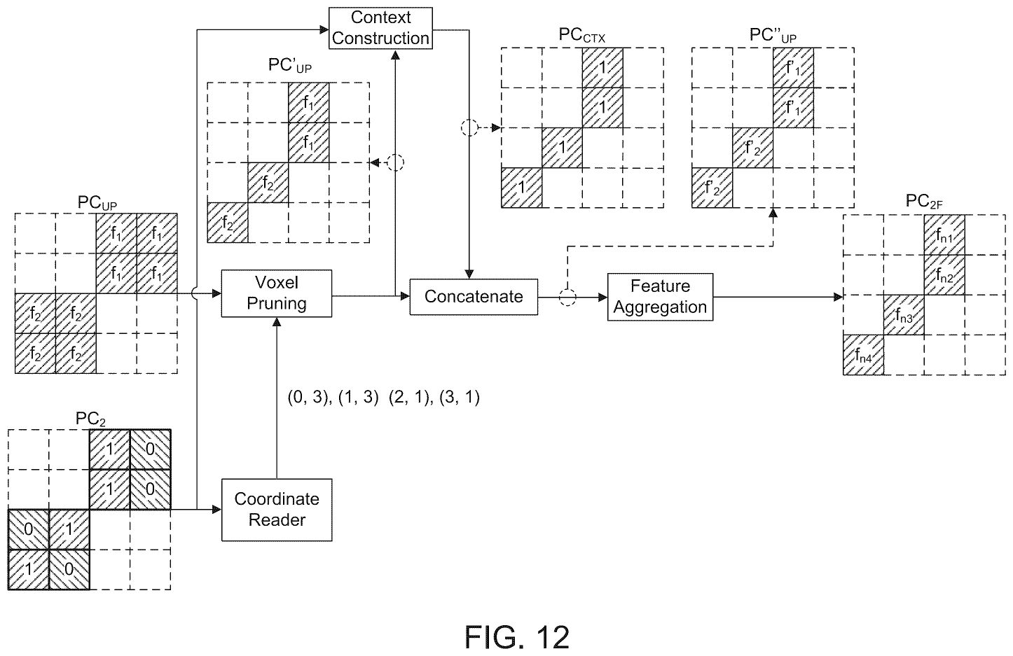

Having finished the encoding of the current LoD, a final step is to compute the voxel-wise feature to prepare for the encoding of the next LoD, as shown in FIG. 12. This step is similar to the other steps encoding a voxel group except that the processing stops right after the feature aggregation module. The output of the feature aggregation module, PC_{2F}, includes the voxel-wise feature for the next LoD. It will be upsampled in the same role as PC_{1F} in FIG. 8.

### Decoder

The decoding process inverts the encoding process where quite a few of the decoding steps and operations are the same as the encoder.

As shown in FIG. 7, suppose we have already decoded the point cloud PC_{1F}— the first LoD of the point cloud equipped with geometric features f₁ and f₂ in its occupied voxels. We aim to decode the second LoD of the input point cloud, PC₂, based on the received bitstream BS. Note that BS includes several sub-bitstreams, BS₁, BS₂, . . . , BS₈ (or BS₄ in this 2-D example) where each sub-bitstream corresponds to one group of voxels/bits as shown in FIG. 4.

Note that at the very beginning when decoding the first LoD of the point cloud (PC₁), the point cloud from its previous LoD, PC_{0F} is simply one voxel representing the whole space. In this case, its geometric feature is set to be a constant. Note that it has to be the same as the constant feature used on the encoder side.

Similar to encoding, the preparation step of applying a voxel upsampling module to PC_{1F} is also needed in decoding, as shown in FIG. 8. This upsampling step serves as a common preparation for the subsequent steps to decode each group of voxels in PC₂.

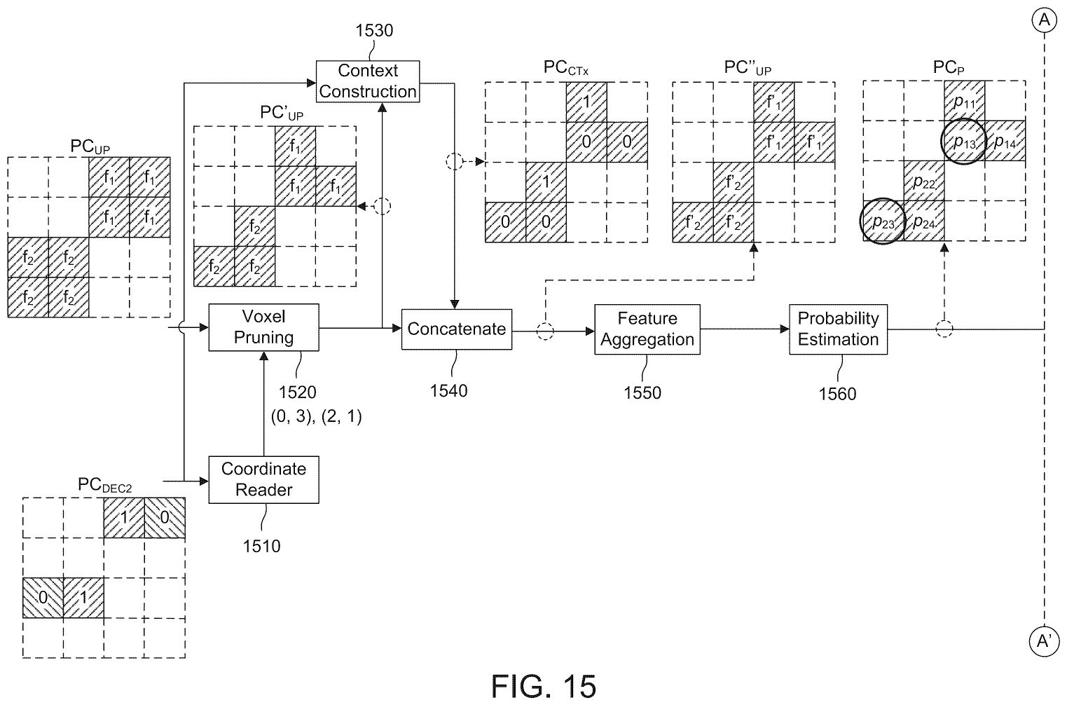

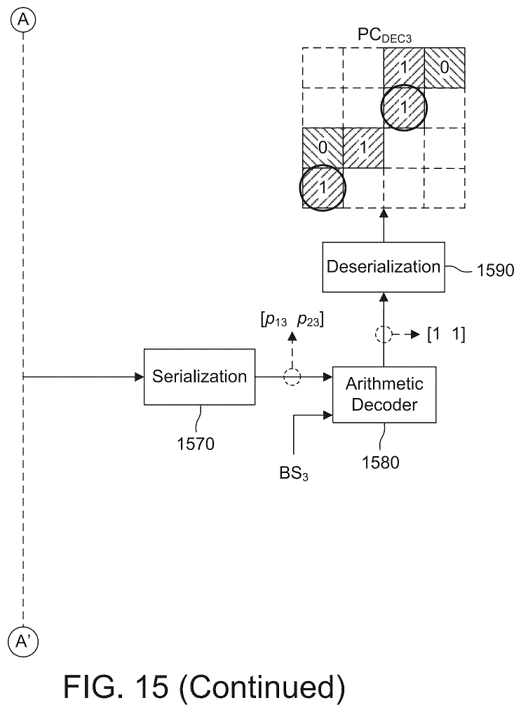

Next, we start the actual decoding process. Similar to the encoding, we start our description with the decoding of the third group of bits in PC₂ (the bits labeled as ‘3’ in FIG. 4), which involves a more general decoding pipeline. The whole decoding pipeline to decode the third group of bits in PC₂ is shown in FIG. 15. In this case, the first and the second groups of bits in PC₂ are already decoded. These decoded bits form an intermediate decoded point cloud PC_{DEC2}, as shown in FIG. 15, and we intend to utilize PC_{DEC2} for context modeling and decoding.

To decode the third group of bits, we need to estimate their occupancy probabilities. The steps to estimate these occupancy probabilities are the same as those during encoding (FIG. 11). Firstly, a coordinate reader module (1510) locates all the already decoded voxels that are empty from PC_{DEC2}. After that, these voxels are removed/pruned from PC_{UP} with the voxel pruning module (1520), leading to the pruned point cloud PC′_{UP}.

Secondly, we construct the context point cloud PC_{CTX} using the context construction module (1530). In one embodiment, we construct binary context information for occupancy probability prediction. For each occupied voxel in PC_{CTX}, if its co-located voxel in PC_{DEC2} is already decoded and occupied, we put a “1” in this voxel; if its co-located voxel in PC_{DEC2} is not decoded yet, we put an “0” in this voxel.

Thirdly, the context point cloud PC_{CTX} and the pruned point cloud PC′_{UP} are concatenated (1540), which puts the voxel-wise feature and the local context information together and results in a point cloud PC″_{UP}. PC″_{UP} is then fed to the feature aggregation module (1550), followed by the probability estimation module (1560), leading to the probability point cloud PCₚ containing the estimated occupancy probabilities.

In the end, the occupancy probabilities of the third voxel group are serialized (1570) and fed to the arithmetic decoder (1580). The arithmetic decoder takes the occupancy probabilities, and the sub-bitstream BS₃ as inputs, and decodes an array—the occupancy bits. These occupancy bits are then deserialized by the deserialization module (1590), which puts these bits back to their associated voxels. This step leads to the updated version of the decoded point cloud, PC_{DEC3} in FIG. 15.

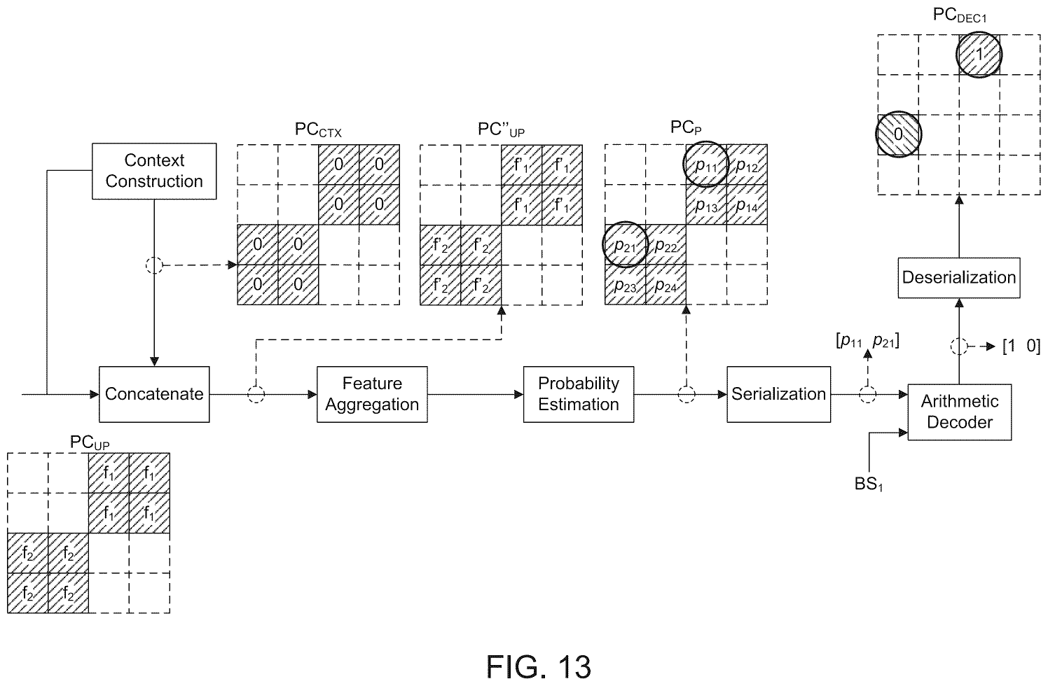

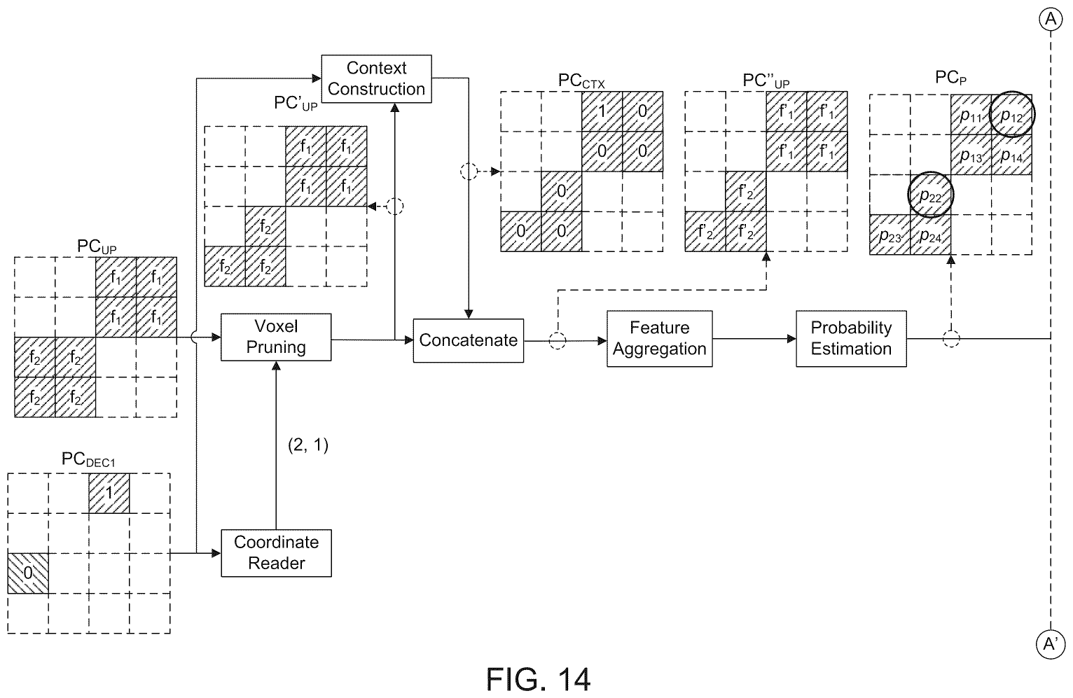

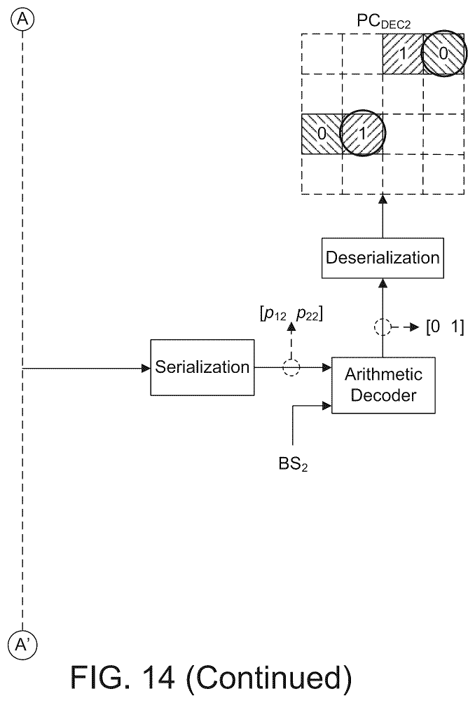

The decoding process of the second voxel group is also illustrated in FIG. 14 which has the same procedure as FIG. 15. Similar to encoding, the decoding of the first voxel group is also a simplified case of the decoding of other voxel groups, as shown in FIG. 13. Because at the beginning of the decoding, there are no voxels/bits that are already decoded, there are no voxels that need to be pruned from PC_{UP}. Thus, PC_{UP} is directly fed to the concatenation module instead of its pruned version. Moreover, the context construction module also directly outputs PC_{CTX} with all zeros on its voxels since there are no decoded voxels. Similar to the encoder side, in a simplified implementation, the voxel groups other than the first voxel group can also follow the process as shown in FIG. 13, namely, voxel pruning (1520) is not performed and/or all contexts are set to zeros. In this case, the information from previously decoded bits is partially used or not used. However, since the geometric information of the previous LoD is propagated to the current LoD through the geometric features in PC_{UP}, the occupancy probability estimation module can still perform reasonably well even though the information from the previously decoded bits is not fully utilized.

Similar to encoding, having finished the decoding of the current LoD, the final step is to compute the voxel-wise feature for decoding the next LoD, as shown in FIG. 12.

### Context Construction

Besides the binary context example illustrated above, the context point cloud, PC_{CTX}, can also include other context information that is helpful for probability estimation.

In one embodiment, the context information is further augmented by the x, y, and z coordinates. Specifically, for an occupied voxel A located at (x, y, z), its feature is the vector f=[x y z].

In another embodiment, the normalized coordinates are used as context information. For PCₙ at the n-th LoD, it has a dimension of 2ⁿ×2ⁿ×2ⁿ, then the feature vector associated with the voxel (x, y, z) in PC_{CTX} is f=[x/2ⁿ y/2ⁿ z/2ⁿ].

Moreover, instead of working with the Euclidean coordinates, one may use the spherical coordinates, which is useful for the case of processing LiDAR sweeps. To do so, we apply the following formula:

$$r = \sqrt{{( x - {2}^{n - 1} )}^{2} + {( y - {2}^{n - 1} )}^{2} + {( z - {2}^{n - 1} )}^{2}}$$

$$ϕ = arccos ( ( y - {2}^{n - 1} ) / r )$$

$$θ = arc tan ( ( y - {2}^{n - 1} ) / ( x - {2}^{n - 1} ) )$$

where r is the radial distance, φ is the elevation angle and θ is the azimuth angle. Then the vector f becomes f=[r φ θ], or f=[r/2ⁿ φ θ] if the distance is normalized.

In another embodiment, the context information can also be the current bit-depth/LoD of PCₙ which is n. In this case, the feature vector of PC′_{CTX} is simply a scalar f=n.

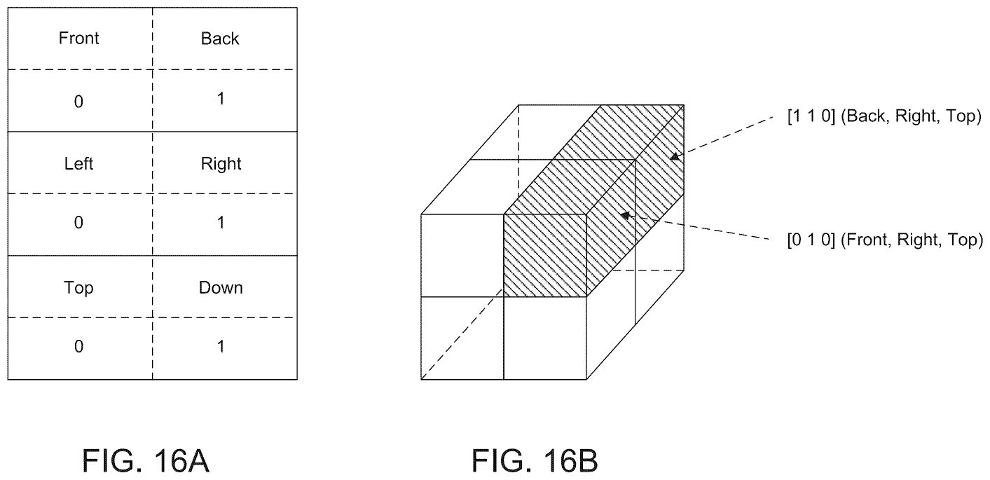

In one embodiment, the context information can also be the positions of the child voxel with respect to its parent voxel. For example, one may represent “front” and “back”, “left” and “right”, “top” and “down” as “0” and “1”, respectively, as shown in FIG. 16A. Then a child voxel located at the front, right, and top of its parent voxel should have a context feature f=[0 1 0] in PC_{CTX} while a child voxel located at the back, right, and top of its parent voxel should have f=[1 1 0], as shown in FIG. 16B. In another embodiment, the three additional bits representing the positions are further converted as a decimal number, e.g., f=[0 1 0] becomes a scalar f=2 and f=[1 1 0] becomes a scalar f=6.

In one embodiment, the augmented context information can be a portion or any combination and permutation of all the aforementioned examples.

### Feature Aggregation

The purpose of the feature aggregation module is to refine the input features so that they can better serve the occupancy probability estimation.

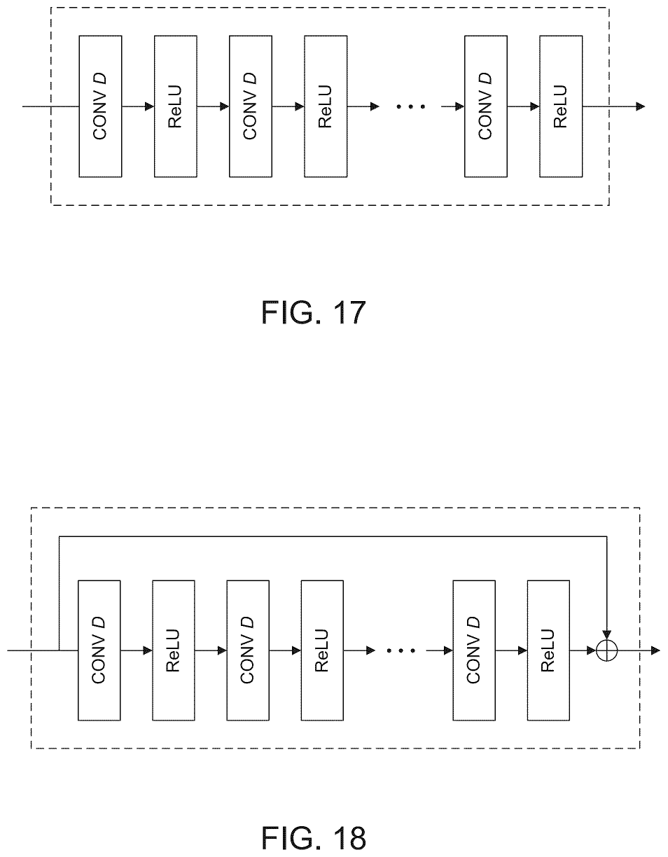

In one embodiment, it is simply a series of sparse 3D convolutional layers with a ReLU activation function following every sparse 3D convolution, as shown in FIG. 17. Note that “CONV D” denotes a sparse 3D convolution layer with D output channels.

In another embodiment, the feature aggregation module takes the ResNet architecture, as shown in FIG. 18. In this example, it shows the architecture of a ResNet block to aggregate features with D channels. Compared to FIG. 17, FIG. 18 introduces a residual connection from the input and added with the output of the convolutional layers.

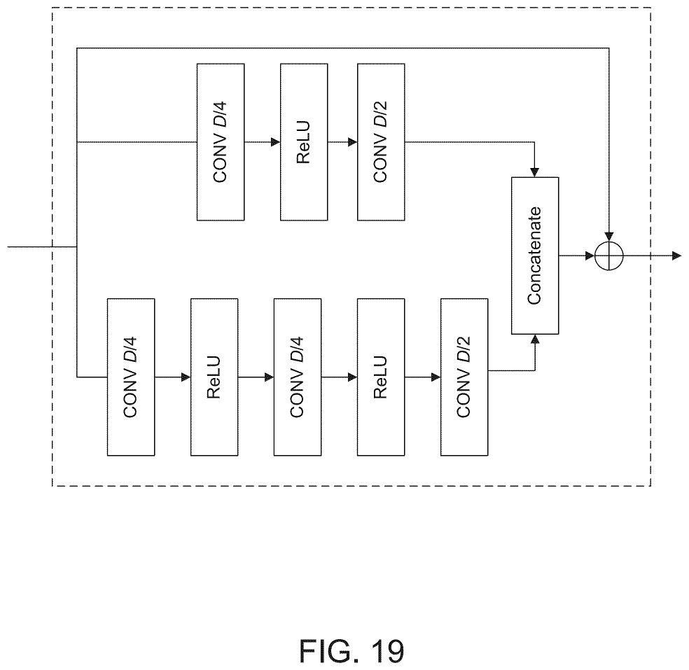

In another embodiment, the feature aggregation module takes the Inception-ResNet (IRN) architecture, as shown in FIG. 19. In this example, it shows the architecture of an IRN block to aggregate features with D channels.

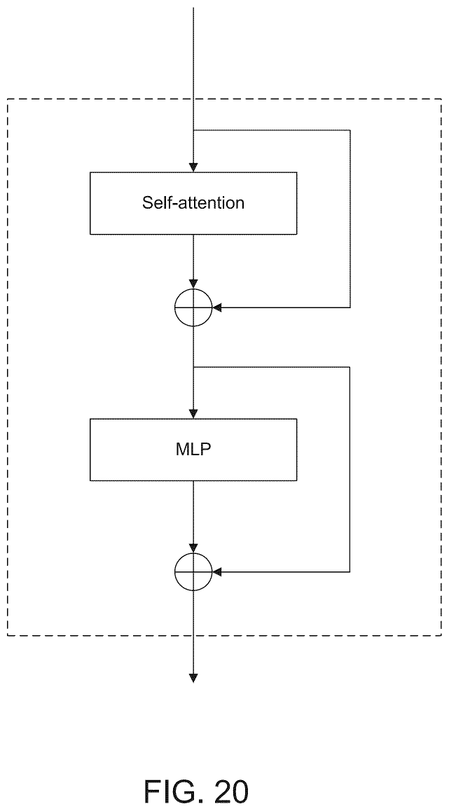

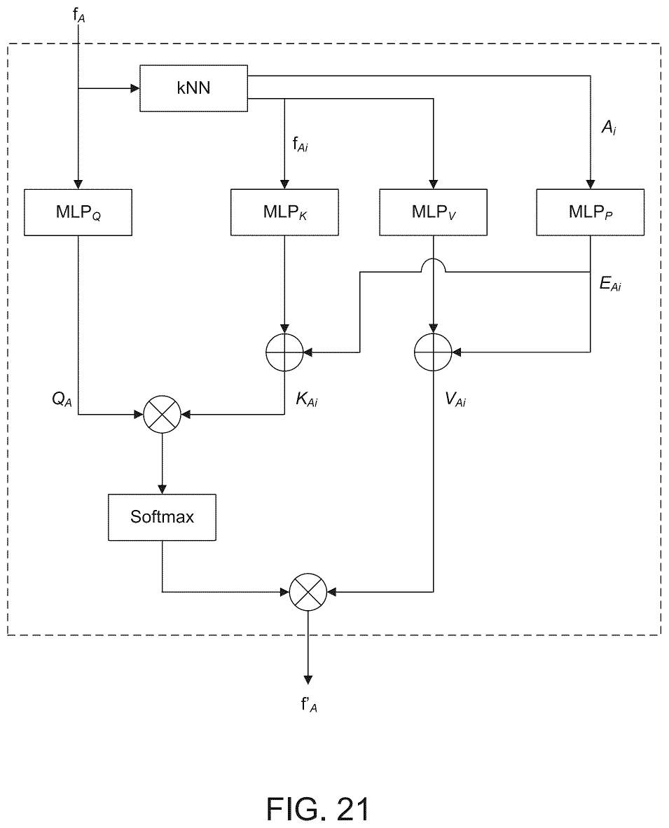

In another embodiment, it takes a transformer architecture similar to the voxel transformer proposed in an article by Mao, Jiageng, et al., entitled “Voxel transformer for 3D object detection,” Proceedings of the IEEE/CVF International Conference on Computer Vision, 2021. The diagram of a transformer block is shown in FIG. 20, which consists of a self-attention block with residual connection, and a MLP block (consisting of MLP layers) with residual connection. The block diagram of the self-attention block is shown in FIG. 21. Its details are described below.

Given a current feature vector f_{A} associated with a voxel location A, and its neighboring k features f_{Ai} associated with voxel locations Aᵢ, where Aᵢ (0≤i≤k−1) are the k nearest neighbors of A in the input sparse tensor, the self-attention block endeavors to update the feature f_{A} based on all the neighboring features f_{Ai}. Firstly, the points Aᵢ are obtained by a k nearest neighbor (kNN) search based on the coordinate of A. Then the query embedding Q_{A} for A is computed with:

$$QA = {MLP}_{Q} ( {f}_{A} ) ,$$

After that, the key embedding K_{Ai} and the value embedding V_{Ai} of all the nearest neighbors of A are computed:

$${K}_{{A}_{i}} = {MLP}_{K} ( {f}_{{A}_{i}} ) + {E}_{{A}_{i}} , {V}_{{A}_{i}} = {MLP}_{V} ( {f}_{{A}_{i}} ) + {E}_{{A}_{i}} , 0 \leq i \leq k - 1 ,$$

where MLP_{Q}(⋅), MLP_{K}(⋅), and MLP_{V}(⋅) are MLP layers to obtain the query, key, and value, respectively, and E_{Ai} is the positional encoding between the voxels A and Aᵢ, calculated by:

$${E}_{{A}_{i}} = {MLP}_{P} ( {P}_{A} - {P}_{{A}_{i}} ) ,$$

where MLP_{P}(⋅) is MLP layers to obtain the positional encoding, P_{A} and P_{Ai} are 3-D coordinates, they are centers of the voxels A and Aᵢ, respectively. The output feature of location A by the self-attention block is:

$${f}_{A}^{′} = {\sum }_{i = 0}^{k - 1} σ ( \frac{{Q}_{A}^{T} \cdot {K}_{{A}_{i}}}{c \sqrt{d}} ) \cdot {V}_{{A}_{i}} ,$$

where σ(⋅) is the Softmax normalization function, d is the length of the feature vector f_{A} and c is a pre-defined constant.

The transformer block updates the feature for all the occupied locations in the sparse tensor in the same way and then outputs the updated sparse tensor. Note that in a simplified embodiment, MLP_{Q}(⋅), MLP_{K}(⋅), MLP_{V}(⋅), and MLP_{P}(⋅) may contain only one fully-connected layer, which corresponds to linear projections.

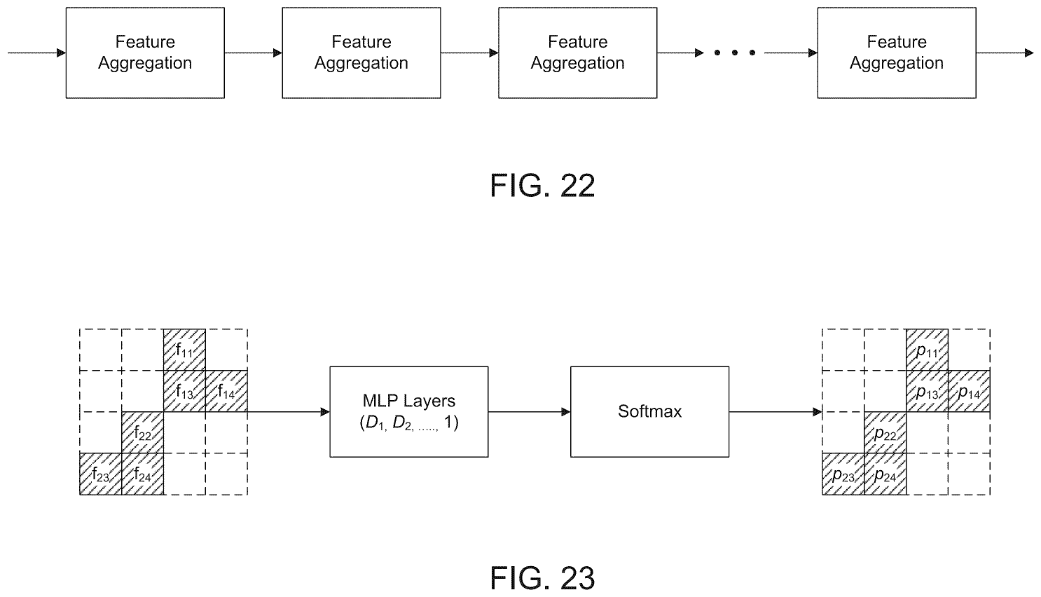

In one embodiment, several feature aggregation blocks (FIG. 17, FIG. 18, FIG. 19, and FIG. 20) are cascaded together to further enhance the performance, as shown in FIG. 22. The feature aggregation blocks can be of the same type, e.g., all of them are transformer blocks. In this case, the parameters of their neural network layers can either be shared or not shared. The feature aggregation blocks can also be a mixture of different types of feature aggregation blocks, e.g., a mixture of the IRN blocks and the transformer blocks.

### Probability Estimation

In one embodiment, the probability estimation module consists of a series of multi-layer perceptron (MLP) layers. Suppose the input point cloud contains vector features of length D₁ residing on its voxels, then the MLP has k layers with channel dimensions (D₁, D₂, . . . , Dₖ₋₁, 1) for classification. The MLP results are then fed to a Softmax function which converts the MLP outputs to the range of 0 to 1, representing the probability values.

### Augmented Voxel Upsampling

In one embodiment, during the preparation step in encoding/decoding (FIG. 8), an additional feature aggregation module is appended right after the voxel upsampling module for initial feature aggregation and refinement. With this additional feature aggregation module, the compression performance can be further improved.

### Training Strategy

In order to obtain the proper neural network parameters for compression, it is necessary to perform training in the first place. To train the neural network modules efficiently, we also propose a training strategy that we call the probabilistic training strategy.

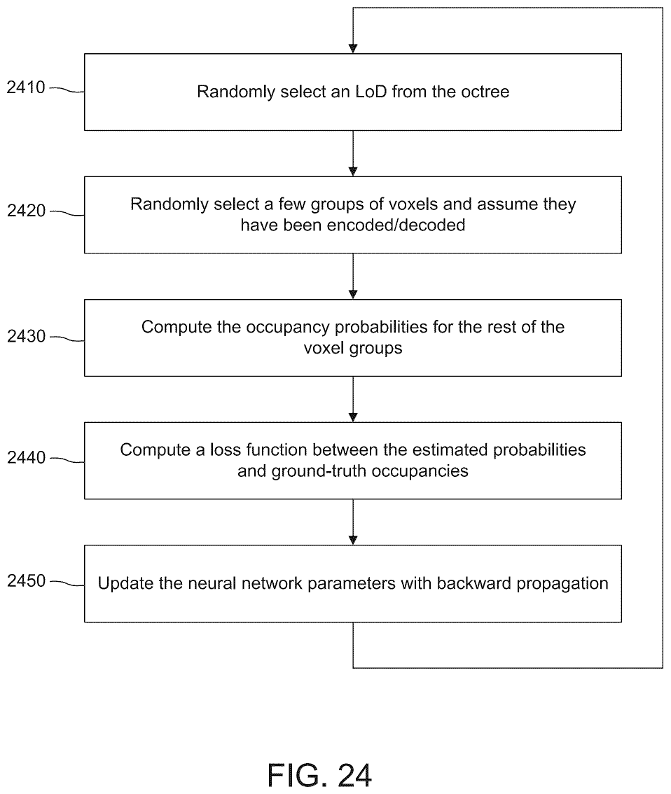

A block diagram of the proposed probabilistic training strategy is shown in FIG. 24, according to an embodiment. In each training step, we first randomly select (2410) one LoD from the octree for training. Specifically, given an input point cloud with a total bit-depth of N, this step randomly generates an LoD from 1 to N. The selected LoD can be drawn according to a predefined probability distribution. In one embodiment, it is drawn according to the uniform distribution. In another embodiment, it is drawn according to a predefined multinomial distribution.

After that, we randomly select (2420) a few groups of voxels from the selected LoD. Specifically, we first randomly pick a number m ranging from 0 to 7 (note that there are 8 groups of voxels in an LoD), then randomly pick m groups of voxels among all the 8 groups. We assume these selected m groups of voxels are already known for context modeling, i.e., they are already encoded/decoded.

Next, we compute (2430) the occupancy probabilities of all the remaining (8−m) groups of voxels, according to the probability estimation process illustrated in FIG. 14 (or FIG. 15) if m≠0, and FIG. 13 if m=0.

In the end, a loss function, for example, a binary cross entropy loss is computed (2440) between the estimated probabilities and the ground-truth occupancies on the selected LoD of the octree. Note that the binary cross entropy loss is a typical loss function for binary classification which characterizes the discrepancy between the occupancy probabilities and the ground-truth occupancy status. The computed binary cross entropy loss is used to perform backward propagation to update (2450) the neural network parameters. This training procedure repeats until a predefined condition is met, e.g., a predefined number of training steps is reached.

### Experimental Results

The proposed method is applied to losslessly encode the Ford point cloud sequences. The Ford dataset is a test dataset recommended by the MPEG G-PCC Common Test Conditions (CTC). It contains 4500 LiDAR frames collected from a driving car for autonomous driving applications. In this experiment, we used 1500 LiDAR frames for training the neural networks while the remaining 3000 LiDAR frames are reserved for testing.

We experimented with an embodiment where voxel pruning is included during encoding and decoding (FIG. 11 and FIG. 15), and the context information additionally includes the normalized coordinates and the current bit-depth/LoD.

Firstly, the results provided by the MPEG G-PCC octree (the standardized method by MPEG, a non-learning method) is 22.35 bpp (bit-per-point, the smaller the better). On the other hand, SparsePCGC provides a bpp of 20.36 using a neural network model with 5.6×10⁶ parameters, while our proposal provides a bpp of 20.21 using a neural network model with 4.9×10⁶ parameters. Therefore, our proposal achieves the best compression performance. When compared to SparsePCGC, we provide better compression performance with a smaller neural network model.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of encoding point cloud data, comprising:
obtaining features associated with point cloud data for a point cloud, said point cloud data is represented as a sparse tensor at a level of detail (LoD);
processing said features associated with said LoD to match a resolution of another LoD, wherein said another LoD is finer and subsequent to said LoD;
for each occupied voxel in said LoD, encoding a plurality of voxels at said another LoD based on said processed features to obtain occupancy information at said another LoD; and
updating said processed features, based on occupancy information at said another LoD, to generate updated features associated with said another LoD.

2. The method of claim 1, wherein said encoding a plurality of voxels at said another LoD comprises, for a current voxel belonging to said plurality of voxels at said another LoD:
obtaining occupancy information of previously encoded voxels of said plurality of voxels at said another LoD;
obtaining context information for encoding said current voxel;
generating an augmented feature by associating said context information with feature of said current voxel;
aggregating another feature for said current voxel based on said augmented feature;
generating an occupancy probability for said current voxel based on said another feature; and
encoding occupancy information for said current voxel, based on said occupancy probability for said current voxel.

3. The method of claim 1, further comprising:
pruning said processed features based on said occupancy information of said previously encoded voxels, wherein said augmented feature is based on said pruned features.

4. The method of claim 1, wherein said features associated with said LoD are upsampled to match said resolution of said another LoD.

5. The method of claim 4, wherein feature aggregation is performed on said upsampled features.

6-16. (canceled)

17. A method of decoding point cloud data, comprising:
obtaining features associated with point cloud data for a point cloud, said point cloud data is represented as a sparse tensor at a level of detail (LoD);
processing said features associated with said LoD to match a resolution of another LoD, wherein said another LoD is finer and subsequent to said LoD;
for each occupied voxel in said LoD, decoding a plurality of voxels at said another LoD based on said processed features to obtain occupancy information at said another LoD; and
updating said processed features, based on occupancy information at said another LoD, to generate updated features associated with said another LoD.

18. The method of claim 17, wherein said decoding a plurality of voxels at said another LoD comprises, for a current voxel belonging to said plurality of voxels at said another LoD:
obtaining occupancy information of previously decoded voxels of said plurality of voxels at said another LoD;
obtaining context information for decoding said current voxel;
generating an augmented feature by associating said context information with feature of said current voxel;
aggregating another feature for said current voxel based on said augmented feature;
generating an occupancy probability for said current voxel based on said another feature; and
decoding occupancy information for said current voxel, based on said occupancy probability for said current voxel.

19. The method of claim 17, further comprising:
pruning said processed features based on said occupancy information of said previously decoded voxels, wherein said augmented feature is based on said pruned features.

20. The method of claim 17, wherein said features associated with said LoD are upsampled to match said resolution of said another LoD.

21. The method of claim 20, wherein feature aggregation is performed on said upsampled features.

22. An apparatus for encoding point cloud data, comprising one or more processors and at least one memory coupled to said one or more processors, wherein said one or more processors are configured to:
obtain features associated with point cloud data for a point cloud, said point cloud data is represented as a sparse tensor at a level of detail (LoD);
process said features associated with said LoD to match a resolution of another LoD, wherein said another LoD is finer and subsequent to said LoD;
for each occupied voxel in said LoD, encode a plurality of voxels at said another LoD based on said processed features to obtain occupancy information at said another LoD; and
update said processed features, based on occupancy information at said another LoD, to generate updated features associated with said another LoD.

23. The apparatus of claim 22, wherein said encoding a plurality of voxels at said another LoD comprises, for a current voxel belonging to said plurality of voxels at said another LoD:
obtaining occupancy information of previously encoded voxels of said plurality of voxels at said another LoD;
obtaining context information for encoding or decoding said current voxel;
generating an augmented feature by associating said context information with feature of said current voxel;
aggregating another feature for said current voxel based on said augmented feature;
generating an occupancy probability for said current voxel based on said another feature; and
encoding occupancy information for said current voxel, based on said occupancy probability for said current voxel.

24. The apparatus of claim 22, wherein said one or more processors are further configured to:
prune said processed features based on said occupancy information of said previously encoded voxels, wherein said augmented feature is based on said pruned features.

25. The apparatus of claim 22, wherein said features associated with said LoD are upsampled to match said resolution of said another LoD.

26. The apparatus of claim 25, wherein feature aggregation is performed on said upsampled features.

27. An apparatus for decoding point cloud data, comprising one or more processors and at least one memory coupled to said one or more processors, wherein said one or more processors are configured to:
obtain features associated with point cloud data for a point cloud, said point cloud data is represented as a sparse tensor at a level of detail (LoD);
process said features associated with said LoD to match a resolution of another LoD, wherein said another LoD is finer and subsequent to said LoD;
for each occupied voxel in said LoD, decode a plurality of voxels at said another LoD based on said processed features to obtain occupancy information at said another LoD; and
update said processed features, based on occupancy information at said another LoD, to generate updated features associated with said another LoD.

28. The apparatus of claim 27, wherein said decoding a plurality of voxels at said another LoD comprises, for a current voxel belonging to said plurality of voxels at said another LoD:
obtaining occupancy information of previously decoded voxels of said plurality of voxels at said another LoD;
obtaining context information for decoding said current voxel;
generating an augmented feature by associating said context information with feature of said current voxel;
aggregating another feature for said current voxel based on said augmented feature;
generating an occupancy probability for said current voxel based on said another feature; and
decoding occupancy information for said current voxel, based on said occupancy probability for said current voxel.

29. The apparatus of claim 27, wherein said one or more processors are further configured to:
prune said processed features based on said occupancy information of said previously decoded voxels, wherein said augmented feature is based on said pruned features.

30. The apparatus of claim 27, wherein said features associated with said LoD are upsampled to match said resolution of said another LoD.

31. The apparatus of claim 30, wherein feature aggregation is performed on said upsampled features.
